(19) United States
(12) Patent Application Publication
(10) Pub. No.: US 2010/0038248 A1
(43) Pub. Date: Feb. 18, 2010

(54) MICROSTRUCTURED FIBER ELECTRODE FOR THE CORONA DISCHARGE INITIATION REACTION

(76) Inventor: Yakov E. Krasik, Nesher (IL)

Correspondence Address: Pearl Cohen Zedek Latzer, LLP, 1500 Broadway, 12th Floor, New York, NY, 10036, US

(21) Appl. No.: 12/532,429

(22) PCT Filed: Mar. 23, 2008
(86) PCT No.: PCT/IL08/00399

§ 371 Date: Sep. 22, 2009

Related U.S. Application Data
(60) Provisional application No. 60/907,144, filed on Mar. 22, 2007.
(60) Provisional application No. 60/907,143, filed on Mar. 22, 2007.

(51) Int. Cl. C02F 1/467

(52) U.S. Cl. 204/554; 204/660

(57) ABSTRACT

An electrode includes a plurality of fiber bundles. Each of the fiber bundles includes a plurality of individual fibers of different lengths with respect to an operation end of the electrode device. A screening ring is provided around the fiber bundles. The electrode may be used for example for generating corona discharge, which may be useful in liquid treatment.

### FIELD OF THE INVENTION

The present invention relates to corona discharge initiation reactions. More specifically, the present invention relates to an improved electrode design for a corona discharge initiation reaction and to an apparatus and method for liquid treatment processes, employing such electrode.

### BACKGROUND OF THE INVENTION

Initiation of a corona discharge may be brought about by applying a high voltage pulse to an electrode, in the neighborhood of another electrode. When the applied voltage has a large enough negative amplitude, the electric field at the surface of the first, high voltage electrode will exceed the threshold, E_{cr}, necessary to initiate a corona discharge.

Depending on the polarity of the high-voltage electrode, either a positive or a negative corona discharge will be generated (Yu P. Raizer, 1987). Assuming the voltage is applied to the electrode with the greater curvature, either type of discharge results in a high density plasma formation in the vicinity of the high-voltage electrode having the stronger curvature, with the density decreasing rapidly towards the second electrode having a smaller curvature.

In the case of point-plane configuration, where the high-voltage electrode is needle-shaped and the second electrode is planar, one can use the approximation: E≈V/5r, as a rough estimate for the electric field E at the point apex, where V is the potential difference between the point apex and the plane.

The total current of the corona discharge consists of electron current and ion current flowing towards the anode and cathode, respectively. The ions are created as a result of background gas ionization by fast energetic electrons. The corona current consists of electrons emitted by the cathode, ion current moving towards the negative electrode and secondary electrons which are created as a result of ionization and ion bombardment of the cathode.

The discharge current and the threshold electric field greatly depend on the curvature of the electrode which can be decreased significantly during the electrode operation because of surface erosion and melting (melting decreases significantly the corona discharge current).

The corona discharge induced reactions have a number of commercial and industrial applications. One of the known applications of corona reactions is the production of oxidizing agents such as ozone (O₃) and hydroxide (OH) radicals which depend on the parameters of the background gases and on the corona discharge.

Ozone has many industrial applications such as, for example, treating of liquids (i.e., oxidizing liquids).

Oxidation processes for treating liquids are used in many fields and industries, such as, for example, the petrochemical industry, refineries, the pharmaceutical industry, the chemical industry, the textile industry, the Pulp & Paper industry, water disinfection, the pesticide industry and many more.

Typical uses of oxidation processes may be in applications such as pretreatment for biological wastewater treatment, wastewater polishing, ground water remediation to treat MTBE (methyl tertiary butyl ether), Dioxane, Trichloro ethylene, perchloro ethylene, and other organo-halogens, landfill leachate treatment, cooling tower water reuse, storm water run-off treatment, and onboard wastewater treatment (in marine vessels).

Thus, as noted above, the corona discharge is widely used in various applications, and since the discharge current and the threshold electric field greatly depend on the curvature of the electrode, it is an aim of the present invention to provide a robust electrode that has longer operation life and better withstands surface erosion and melting.

More specifically, the present invention is aimed at disclosing an improved design of a discharge electrode which facilitates intense corona discharge and possesses a longer operation life time than the operation life time of conventional electrodes which are commonly based on thin wires or on needles made of hard material such as tungsten or stainless steel.

Another object of some embodiments of the present invention is to use the improved discharge electrode in liquid treatment processes.

Further features of the discharge electrode and its use in liquid treatment processes according to preferred embodiments of the present invention will be explained in detail below with reference to the attached drawings.

### SUMMARY OF THE INVENTION

There is thus provided, according to embodiments of the present invention an electrode which includes a plurality of fiber bundles. Each of the fiber bundles includes a plurality of individual fibers of different lengths with respect to an operation end of the electrode device. A screening ring is provided around the fiber bundles.

Furthermore, according to embodiments of the present invention, each of said fiber bundle has a diameter of a few millimeters.

Furthermore, according to embodiments of the present invention, each of said fiber bundle has an external diameter in the range of between 1 to 5 mm.

Furthermore, according to embodiments of the present invention, each of said individual fibers has a diameter of a few micrometers.

Furthermore, according to embodiments of the present invention, each of said individual fibers has a diameter in the range of between 5 to 20 micrometers.

Furthermore, according to embodiments of the present invention, each of the fiber bundles includes thousands of individual fibers.

Furthermore, according to embodiments of the present invention, the number of individual fibers in each bundle is in the range of between 1000 to 6000.

Furthermore, according to embodiments of the present invention, each of said individual fibers is made of carbon.

Furthermore, according to embodiments of the present invention, there is provided a reactor for oxidizing and disinfecting liquids which includes a container having an electrically conductive open channel serving as a first electrode and a second electrode positioned opposite the first electrode. A high voltage generator is coupled to said second electrode.

Furthermore, according to embodiments of the present invention, the first electrode is made from a metallic material.

Furthermore, according to embodiments of the present invention, the second electrode includes a plurality of fiber bundles, each of the fiber bundles comprising a plurality of individual fibers of different lengths with respect to an operation end of the electrode device; and a screening ring around the fiber bundles.

Furthermore, according to embodiments of the present invention, there is provided a method for oxidizing and disinfecting liquids. The method includes providing a first electrode and a second electrode. The second electrode includes a plurality of fiber bundles, each of the fiber bundles comprising a plurality of individual fibers of different lengths with respect to an operation end of the electrode device and a screening ring around the fiber bundles. Liquid is passed over the first electrode and pulses of high voltage are generated to the second electrode which is positioned opposite the first electrode over the liquid causing generation of corona discharge between the second electrode and the surface of the water.

Furthermore, according to embodiments of the present invention, the step of generating pulses of high voltage causing corona discharge is repeated to create an ionized path.

### BRIEF DESCRIPTION OF THE DRAWINGS

In order to better understand the present invention, and appreciate its practical applications, the following figures are provided and referenced hereafter. It should be noted that the figures are given as examples only and in no way limit the scope of the invention. Like components are denoted by like reference numerals.

FIG. 1 is a top-view schematic illustration of a microstructured fiber corona discharge electrode in accordance with embodiments of the present invention.

FIG. 2 is a cross sectional side-view of a microstructured fiber corona discharge electrode in accordance with embodiments of the present invention.

FIG. 3 is a schematic illustration of a corona discharge electrode according to embodiments of the present invention, showing the plasma region created in proximity to the edges of the fibers.

FIG. 4 is a block diagram that illustrates a method for treating liquids via corona discharge initiation reactions in a reactor operated under atmospheric pressure conditions in accordance with embodiments of the present invention.

FIG. 5 illustrates a reactor for water treatment under atmospheric conditions employing a corona discharge electrode according to embodiments of the present invention.

### DETAILED DESCRIPTION OF EMBODIMENTS

In the following detailed description, numerous specific details are set forth in order to provide a thorough understanding of the invention. However it will be understood by those of ordinary skill in the art that the present invention may be practiced without these specific details. In other instances, well-known methods, procedures, components and circuits have not been described in detail so as not to obscure the present invention.

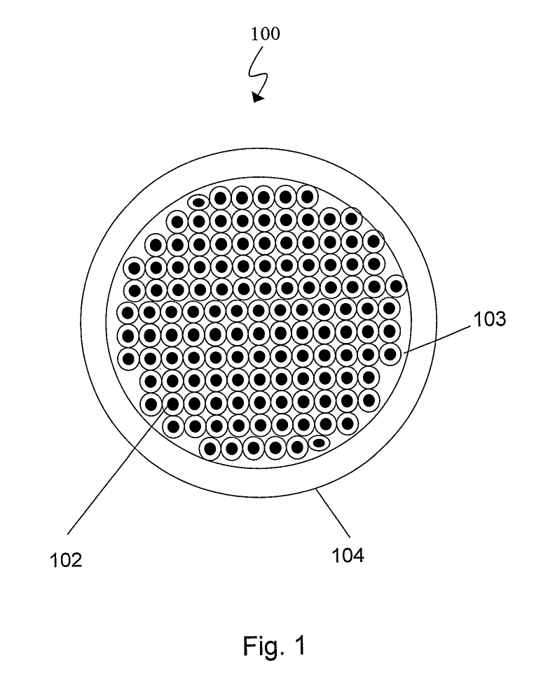

Referring now to FIG. 1, microstructured fiber corona discharge electrode 100 may include one or more (typically a plurality of) fiber bundles 102, which are typically made of carbon fibers (or microtubes) in accordance with embodiments of the present invention. However, the use of other materials for the manufacturing of bundles of fibers other than carbon may be possible.

Fiber bundles 102, which may be provided with cladding 103, may be surrounded by a screening ring 104 as seen in the figure, electrically connected to the surface of either an anode or a cathode holder.

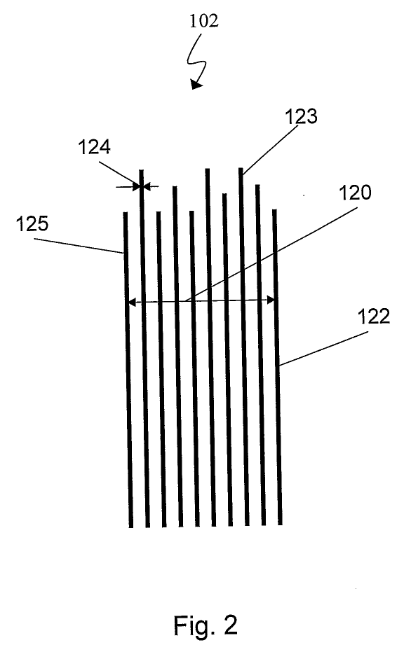

Referring now to FIG. 2, each fiber bundle 102 may have a diameter 120 typically of a few millimeters and may include many single fibers (or microtubes) 122 each having a diameter 124 typically of a few micrometers.

As seen in the figure, individual fibers 122 do not possess the exact same length at the operation end of the electrode device (the end that faces the opposite electrode). Therefore, as the electric field is stronger over the tips of the longest fibers 123 initially the latter participate in the production of corona discharge initiation reaction.

During the corona discharge operation, the emitting fibers may lose height and recede, allowing other fibers to participate in the corona discharge. Considering that each bundle typically includes several thousands of individual fibers, the operation life time of such an electrode is substantially longer than the operation life time of a needle electrode.

It should be noted that the sharp edges of the fibers generate a relatively strong electric field which may cause an intense corona discharge that is greater than the corona discharge created by the conventional electrode emitters which are commonly used.

Thus, a microstructured fiber electrode according to embodiments of the present invention is superior to the conventional electrode for corona discharge as it provides an intense corona discharge and possesses a longer life-time than the life time of the conventional electrode.

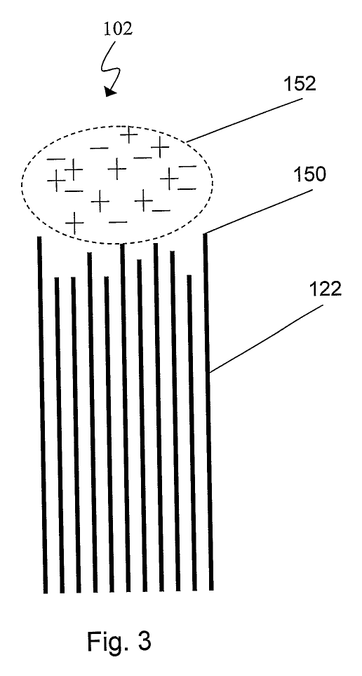

Referring now to FIG. 3, a strong electric field at the top edges 150 of fibers 122 leads to the creation of a plasma region 152.

As noted earlier, the corona discharge has numerous commercial and industrial applications as corona discharge electrodes can be used in “volume discharge” processes.

A “volume discharge” process is based on the development of electron streamers in a gas positioned between two electrodes. In this process, electrons, emitted from sharp edges or other electric field concentration points on the surface of the electrode coupled to the voltage source, gain on their “free run” path before collision enough energy to ionize a gas atom, producing at least one (but typically more than one) new electron that accelerates in the direction of the ground electrode.

The process is repeated many times, leaving an ionized path. This is a substantially high-impedance process, and a large number of streamers are developed simultaneously.

If the voltage pulse duration is shorter or comparable with the streamer development time, an arc stage discharge is not reached, and thus, heat is not created.

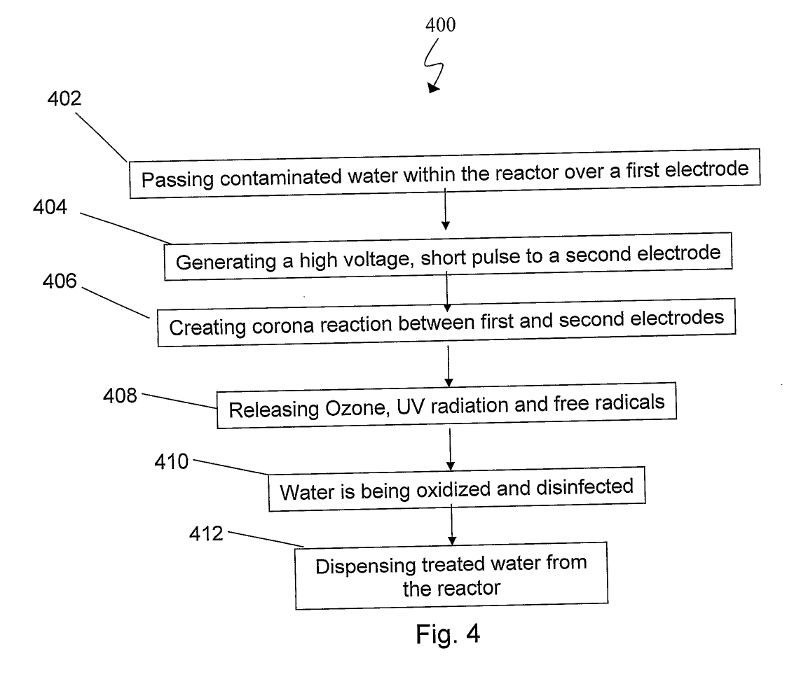

Referring now to FIG. 4, block diagram 400 illustrates a method for treating water via corona discharge initiation reaction. As seen in the figure, the method comprises: passing contaminated water within a reactor over a first electrode (operation 402), generating a high voltage, short pulse to a second electrode (operation 404), corona reaction is created between first and second electrodes (operation 406), ozone, UV radiation and free radicals are released (operation 408), water is being oxidized and disinfected (operation 410) and treated water exits the reactor (operation 412).

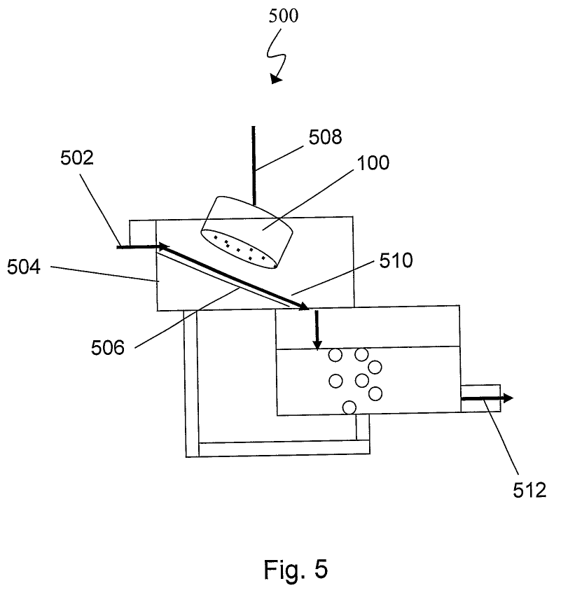

Referring now to FIG. 5, reactor 500 is utilized for treating water. As seen in the figure, contaminated water 502 flows within reactor 504 having a metallic open channel serving as a first electrode 506. The second electrode, which may be, for example, microstructured fiber corona discharge electrode 100, is positioned above water surface 510.

Upon generation of high voltage pulses from a high voltage, short pulse generator 508 which is coupled to microstructured fiber corona discharge electrode 100, an electric discharge between microstructured fiber corona discharge electrode 100 and water surface 510 is generated causing a corona reaction which releases ozone, UV radiation and free radicals which oxidize and disinfect contaminated water 502.

Treated water 514 then exits reactor 504.

It should be noted that corona discharge electrodes other than the microstructured fiber corona discharge electrode can be used as well in the above described liquid treatment process. However, using a microstructured fiber corona discharge electrode according to embodiments of the present invention would result in strong corona discharges and greatly reduce the frequency of replacing worn out discharge electrodes.

1. An electrode comprising:
a plurality of fiber bundles, each of the fiber bundles comprising a plurality of individual fibers of different lengths with respect to an operation end of the electrode device; and
a screening ring around the fiber bundles.

2. The electrode of claim 1, wherein each of said fiber bundle has a diameter of a few millimeters.

3. The electrode of claim 1, wherein each of said fiber bundle has an external diameter in the range of between 1 to 5 mm.

4. The electrode of claim 1, wherein each of said individual fibers has a diameter of a few micrometers.

5. The electrode of claim 1, wherein each of said individual fibers has a diameter in the range of between 5 to 20 micrometers.

6. The electrode of claim 1, wherein each of the fiber bundles includes thousands of individual fibers.

7. The electrode of claim 1, wherein the number of individual fibers in each bundle is in the range of between 1000 to 6000.

8. The electrode of claim 1, wherein each of said individual fibers is made of carbon.

9. A reactor for oxidizing and disinfecting liquids comprising:
a container having an electrically conductive open channel serving as a first electrode;
a second electrode positioned opposite the first electrode;
a high voltage generator coupled to said second electrode.

10. The reactor of claim 9, wherein said first electrode is made from a metallic material.

11. The reactor of claim 9, wherein said second electrode comprises a plurality of fiber bundles, each of the fiber bundles comprising a plurality of individual fibers of different lengths with respect to an operation end of the electrode device; and a screening ring around the fiber bundles

12. The reactor of claim 11, wherein each of said fiber bundle has a diameter of a few millimeters.

13. The reactor of claim 12, wherein each of said fiber bundle has an external diameter in the range of between 1 to 5 mm.

14. The reactor of claim 11, wherein each of said individual fibers has a diameter of a few micrometers.

15. The reactor of claim 11, wherein each of said individual fibers has a diameter in the range of between 5 to 20 micrometers.

16. The reactor of claim 11, wherein each of the fiber bundles includes thousands of individual fibers.

17. The reactor of claim 11, wherein the number of individual fibers in each bundle is in the range of between 1000 to 6000.

18. The reactor of claim 11, wherein each of said individual fibers is made of carbon.

19. A method for oxidizing and disinfecting liquids comprising:
providing a first electrode and a second electrode, the second electrode comprising a plurality of fiber bundles, each of the fiber bundles comprising a plurality of individual fibers of different lengths with respect to an operation end of the electrode device and a screening ring around the fiber bundles
passing liquid over the first electrode; and
generating pulses of high voltage to the second electrode which is positioned opposite the first electrode over the liquid causing generation of corona discharge between the second electrode and the surface of the water.

20. The method as claimed in claim 19, wherein the step of generating pulses of high voltage causing corona discharge is repeated to create an ionized path.
